(19) United States
(12) Patent Application Publication
(10) Pub. No.: US 2004/0159235 A1
(43) Pub. Date: Aug. 19, 2004

(54) Low pressure drop canister for fixed bed scrubber applications and method of using same

(76) Inventors: Paul J. Marganski, Ansonia, CT (US); Theodore A. Shreve, Watertown, CT (US); Joseph Sweeney, Brookfield, CT (US); W. Karl Olander, Indian Shores, FL (US); Jose Arno, Brookfield, CT (US); Mark Holst, Sunnyvale, CA (US)

Correspondence Address: ATMI, INC., 7 COMMERCE DRIVE, DANBURY, CT, 06810, US

(21) Appl. No.: 10/370,159

(22) Filed: Feb. 19, 2003

(51) Int. Cl. B01D 53/02; B01D 59/26

(52) U.S. Cl. 95/116; 96/108

(57) ABSTRACT

An apparatus and method are provided for treating pollutants in a process effluent stream. The apparatus comprises an up-flow canister having a lower section plenum space, a section for a sorbent bed material, an upper section plenum space, an inlet for introducing a process effluent stream to the lower section plenum space, and an outlet for egress of the process effluent stream from the canister, the inlet, lower section plenum space, and sorbent bed material being arranged in a manner which provides for process effluent stream to flow into the sorbent bed against gravity, by a pressure differential.

### BACKGROUND OF THE INVENTION

1. Field of the Invention

This invention relates to an apparatus and method for effecting the sorptive removal from effluent streams, of organic and inorganic hazardous gases, such as arsine, phosphine, and boron trifluoride, which are widely encountered in the manufacture of semiconductor devices.

2. Background of the Related Art

The gaseous effluent from the manufacturing of semiconductor materials, devices, products and memory articles involves a wide variety of chemical compounds used and produced in a semiconductor process facility. They contain inorganic and organic compounds, breakdown products and a wide variety of other gases, which must be removed from waste gas streams before being vented from the facility.

In ion implantation, gases such as AsH₃, PH₃, and BF₃ are introduced into a source chamber where they are bombarded with electrons to produce charged particles. The charged particles are extracted from the source chamber to create a continuous beam. The beam of particles is then filtered, accelerated, and implanted into the substrate material. Effluent gases are extracted from the tool at various points along the beam path and exhausted with high vacuum turbo molecular and cryogenic pumps during beam generation and implant modes. Periodic maintenance of the cryogenic pumps is required to release gases that are trapped and stored at low temperatures. The trapped gases escape during regeneration mode resulting in pressure and flow swings in the effluent manifold.

In CVD gases such as SiH₄, N₂O, NH₃, and PH₃ are delivered to a process chamber where they typically enter a strong RF field, which acts to break down the gases into reactive radicals. During film deposition mode, these radicals migrate to the substrate surface where they pair with a reaction partner to form the desired film. Gases that are not broken down by the plasma, along with residual gas by-products are then removed from the chamber and pumped out as effluent.

During chamber clean mode, reactive gases such as HCl, F₂, and NF₃ are flowed into the chamber to react with and remove solid by-products created during deposition. The radicals created by the plasma flow to areas in the chamber where excess film accumulates and react with the deposited film creating gaseous by-products. The by-products are then removed from the chamber and pumped out as effluent.

The source gases used in ion implantation and CVD along with reaction by-products are typically both hazardous and toxic. Due to their characteristics, it is preferable to remove these components from the effluent gas stream at the point of use. This is because their concentration in the effluent gas stream typically exceeds TLV (Threshold Limit Value) and in some cases, IDLH (Immediately Dangerous to Life and Health).

Ongoing research focused on reducing emission levels of such toxic gases from the effluent waste streams of semiconductor manufacturing processes, involves the optimization of abatement processes. Current processes include a variety of thermal, wet and/or dry scrubbing operations.

Wet scrubbing may be employed to remove targeted chemicals from the effluent gas stream. Such a scrubbing technique generates large quantities of corrosive and hazardous waste water, which typically require further treatment. Further, given the nature of the chemicals to be removed, it is typically necessary to add reagents to the scrubber. The addition of such reagents requires extra injection equipment, increases operating costs, and may result in fouling of internal components.

Thermal scrubbers react an oxidizing agent (almost always air) with a target component (e.g. AsH₃, PH₃, etc.) in a process effluent stream to produce an oxidized species of the target component (e.g. As₂O₃, P₂O₅ etc.). The oxidized species is then removed from the effluent stream by contacting the stream with a gas absorption column (water scrubber). The disadvantages of such a system are (a) it is energy intensive in that it requires significant amounts of electricity and/or fuel, such as H₂ or CH₄, (b) it requires water, (c) it produces an aqueous hazardous waste stream when it scrubs toxic or corrosive compounds and (d) it contributes to green house gases.

Dry scrubbing involves contacting the effluent gas with a solid material which functions to remove target gases from the effluent stream through processes known as adsorption and chemisorption.

Dry scrubber abatement systems offer specific advantages in comparison to both wet and thermal systems, including, high destruction removal efficiencies (DRE), low cost of ownership, no moving parts, small waste generation, non-flammable materials and nonreversible reactions. Further, dry scrubbing systems may have an up-time performance of greater than 99 percent.

In spite of their multiple advantages, current dry scrubber systems are not capable of meeting several process parameter challenges.

For example, introduction of process effluent gases into a fixed bed typically originates from a single inlet with the scrubber and as such the gases are not generally distributed well enough to provide for sufficient distribution of flow, into and through the bed, resulting in flow channeling. Several negative consequences result when the effluent gas channels through a fixed bed. The first is localized heating. Sorption of target gases and related exothermic reactions can result in significant overheating of the bed material. Gas channeling also results in poor utilization of the bed material as portions of the bed material can sometimes avoid contact with the effluent flow through the scrubber. The result is a decrease in lifetime expectancy of the fixed bed.

It is not uncommon in fixed bed designs to inject the effluent gas stream into the top of the canister. For effluent streams with entrained particles, this can result in bed plugging. When flowing through the fixed bed, the entrained particles can become embedded in the matrix of solid sphere or bed material. This increases the need to generate a motive force to draw or push the effluent stream through the fixed bed, resulting in increased loading on the on-board flow assisting device.

In typical ion-implant and CVD operations, it is preferable for safety reasons to maintain the pressure upstream of the fixed resin bed below atmospheric pressure. To achieve this, an eductor or some other form of on-board flow assisting device is used. The eductor uses high pressure N₂ to create a vacuum, which is maintained at a set level. Typically the eductor device is mounted just downstream of the fixed bed and the amount of N₂ that the eductor uses is proportional to the pressure drop across the fixed bed reactor.

In the operation of these processes, flows from semiconductor tools are sometimes highly transient in nature and during maintenance modes, process chamber pump-downs, and high vacuum pump purges, momentary conditions in which the pressure upstream of the fixed bed is considerably higher than atmospheric pressure occurs. This is due to the pressure drop that is created when the large volume of the process chamber is quickly sent though the fixed resin bed and eductor. To overcome the increased pressure losses through the dry scrubber, it is necessary to increase the use of N₂ or other motive force of the on-board flow-assisting device.

Canisters used to encase the dry scrubber sorption material are required to be shipped from facility to facility and disposed according to regulatory requirements following use. It is generally preferable to dispose of the spent material in a way that destroys both the canister and its contents. Thermal incineration facilities can be used to satisfy this requirement. However, when feeding the canister and material to the incinerator, it is necessary to shred the incoming material. It is preferable therefore, to design a canister that can be easily shredded by incineration facilities.

Accordingly, it would be a significant advance in the art to overcome the aforementioned problems and is an object of the invention to avoid the obstacles created by current dry scrubber designs.

Other objects and advantages will be more fully apparent from the ensuing disclosure and appended claims.

### SUMMARY OF THE INVENTION

The present invention relates generally to an abatement apparatus having increased efficiency and capacity for abatement of a toxic gas component from a semiconductor process effluent stream relative to prior art abatement systems.

In one aspect, the invention relates to an abatement apparatus, comprising an up-flow canister, which when joined in fluid flow communication with an effluent gas stream comprising a hazardous component, reduces the concentration of the hazardous component in the effluent gas stream.

In a further aspect the present invention relates to an up-flow canister comprising:

a lower section plenum space;

a center section space, for contaimnent of a sorbent bed material;

an upper section plenum space;

an inlet comprising means for introducing a process effluent stream to the lower section plenum space; and

an outlet comprising means for egress of said process effluent stream from said canister.

In a further aspect, the invention relates to an abatement system, comprising an up-flow canister joined in fluid flow communication with a semiconductor process apparatus, with the semiconductor process apparatus discharging an effluent gas stream to the up-flow canister for removing hazardous effluent species from the effluent gas stream.

In a further aspect, the present invention, relates to an abatement system, comprising an up-flow canister joined in fluid flow communication with a semiconductor process apparatus, with the semiconductor process apparatus discharging an effluent gas stream to the up-flow canister for receiving and removing hazardous effluent species from the effluent gas stream, the up-flow canister comprising:

a lower section plenum space;

a center section space, for containment of a sorbent bed material;

an upper section plenum space;

an inlet comprising means for introducing the process effluent stream to the lower section plenum space, said inlet in gas flow communication with the semiconductor process effluent stream; and

an outlet comprising means for egress of the process effluent stream from the canister.

In a still further aspect, the present invention relates to a method for reducing the concentration of a toxic gas component in a semiconductor process effluent stream, comprising:

introducing an effluent gas stream comprising a toxic gas component into an up-flow canister, said up-flow canister comprising:

a lower section plenum space;

an upper section plenum space;

a center section comprising a sorbent bed material;

an inlet comprising means for introducing a process effluent stream to the lower section plenum space; and

an outlet comprising means for egress of said process effluent stream from said canister; and

contacting the effluent stream with a sorbent material that is reactive with the toxic gas component, to substantially remove the toxic component therefrom,

wherein said effluent gas stream flows into the sorbent bed, in an upward direction, by a pressure differential.

In a further aspect, the present invention relates to an abatement apparatus comprising a canister for coupling with an abatement system, wherein said canister comprises a cubic geometry.

Other aspects, features and embodiments will be more fully apparent from the ensuing disclosure and appended claims.

### BRIEF DESCRIPTION OF THE DRAWINGS

FIGS. 1A and 1B show a comparison of a prior art down-flow canister design and an up-flow canister design according to one embodiment of the present invention.

FIGS. 2A, 2B and 2C show one modification of the up-flow canister according to one embodiment of the present invention.

FIGS. 3A and 3B show a further modification of the up-flow canister according to another embodiment of the present invention.

FIGS. 4A and 4B show an up-flow canister where the inlet has been modified according to a further embodiment of the present invention.

FIGS. 5A and 5B show an up-flow canister where the inlet has been modified according to a further embodiment of the present invention.

FIG. 6 shows a prior art fixed resin bed abatement system used to target various effluent gas species.

FIG. 7 shows a direct comparison in the form of a bar graph for pressure drop reduction resulting from an up-flow canister design at 35 and 99 CFM.

FIG. 8 shows a typical ion implant system according to one embodiment of the present invention.

FIGS. 9A and 9B show a comparison of fluid flow distribution between a prior art down-flow canister and the up-flow canister of the instant invention.

FIG. 10 shows a cubic shaped canister according to one embodiment of the present invention.

FIG. 11, shows a process tool using a point of use abatement apparatus according to one embodiment of the present invention.

FIG. 12 shows a plot of particle trapping efficiency of an up-flow canister as a function of particle size, according to one embodiment of the present invention.

### DETAILED DESCRIPTION OF THE INVENTION AND PREFERRED EMBODIMENTS THEREOF

The present invention provides an abatement apparatus and process for removing pollutants from effluent gaseous streams, which are preferably derived from a semiconductor process tool.

The apparatus comprises a lower section plenum space, where process effluent is introduced; a sorbent bed section for treating the effluent by removing pollutants therefrom, to achieve a target abatement performance; and an upper section plenum space where treated effluent passes prior to exiting the system to atmosphere, house-exhaust or other disposition steps.

The abatement apparatus accommodates the collection of hazardous gases, typically considered pollutants, in an effluent gas stream by contacting the effluent gas stream with a sorbent material, which may be fixed or fluidized and may work by physical adsorption or irreversible chemisorption.

The instant invention provides for the continuous monitoring of the abatement apparatus to determine the approach to exhaustion of the capacity of the sorbent material to remove undesired components from the effluent gas stream.

The abatement apparatus of the instant invention comprises a canister having any shape or size useful for processing an effluent stream comprising a hazardous component. In a preferred embodiment, the canister is of a cylindrical or cubic geometry having a volume that is between 0.1 to 1000 liters.

The three main components of the interior section of the canister, mainly lower and upper plenum space and sorbent bed sections, may occupy any percent of the interior section and may be readily determined by one skilled in the art. Variables effecting the volume occupied by each of the three sections include but are not limited to process, volumes of toxic component to be abated, resin choice, effluent fluid flow, canister shape, inlet design etc.

A cubic container may be adapted to minimize volumetric space requirements in storage, transport and use. In one specific embodiment, the abatement apparatus includes a cubic up-flow canister having at least an upper and lower plenum space and a sorbent bed therebetween.

As used herein the terms “cube and “cubic” are interchangeable and are defined as having three dimensions and six faces, where the angle between any two adjacent faces is a right angle.

The invention entails a change in dry resin bed scrubber designs with respect to geometry and structure. The inventors of the present invention have discovered that by changing the dynamics of fluid flow in a fixed bed canister, both capacity of the sorbent material and process efficiency are improved.

As used herein, the up-flow canister is intended to be broadly construed, and may alternatively comprise, consist, or consist essentially of the specific stated components hereafter specifically identified.

As used herein, the term effluent gas stream is to be broadly construed as including effluent streams deriving from any industrial source having a potential for releasing a hazardous component to its immediate environment. The hazardous component may be in the form of a fluid wherein the fluid may further comprise particulate or other matter. Further, the effluent gas stream may be pretreated or modified prior to or subsequent to abatement treatment according to the present invention.

The present invention provides an up-flow canister comprising:

lower section plenum space;

center section space, for containment of a dry resin sorbent bed material;

an upper section plenum space;

an inlet comprising means for introducing an effluent stream comprising a hazardous component to the lower section plenum space; and

an outlet comprising means for egress of said process effluent stream from said canister.

The up-flow canister reverses the fluid flow of a typical fixed bed canister from a down-flow direction to an up-flow configuration whereby process fluid is mass transported into the fixed sorbent bed section, in an upward direction, by a pressure differential.

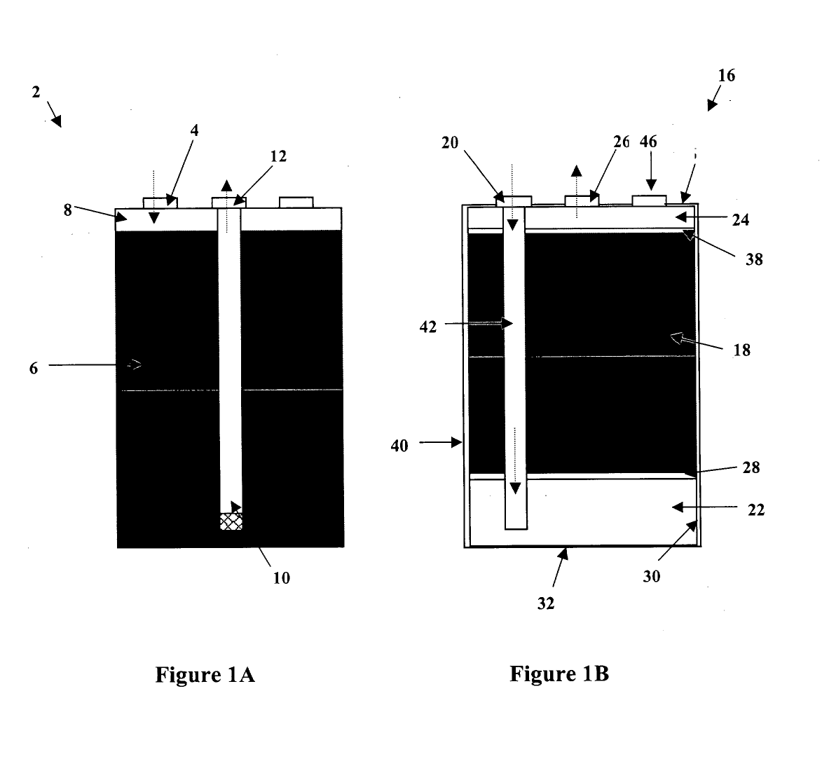

FIGS. 1A and 1B show a comparison of a prior art down-flow canister design and an up-flow canister design according to one embodiment of the instant invention. In the prior art canister 2 of FIG. 1A, fluid flows (shown by directional arrows) from scrubber inlet 4 into and through the sorbent bed 6 from the top plenum space 8. A high-pressure drop is associated with such a down-flow design because the fluid stream must converge into the exhaust dip tube 10 connected to outlet 12, thereby creating locally high gas velocities, which result in high pressure drops in accordance with the Ergun equation (below).

$$\frac{Δ P}{L} = \frac{150 {V}_{o} {µ ( 1 - ϵ )}^{2}}{{g}_{c} {φ}_{s}^{2} {D}_{p}^{2} {ϵ}^{3}} + \frac{1.75 {ρ V}_{o}^{2} ( 1 - ϵ )}{{g}_{c} {φ}_{s} {D}_{p} {ϵ}^{3}}$$

Ergun Equation:

ΔP=pressure drop, lbf/ft²

L=bed length, ft

Vₒ=linear velocity, ft/sec

μ=gas viscosity, lbm/(ft*sec)

ε=bed void fraction

ρ=gas density, lbm/ft³

Dₚ=characteristic resin particle diameter, ft

φₛ=sphericity of resin particle (1 for spheres, ˜0.6 for granules)

gₑ=units conversion factor=32.2 (lbm*ft)/(lbf*sec²)

FIG. 1B shows an up-flow canister design according to one embodiment of the present invention. Fluid flows (as shown by directional arrows) from scrubber inlet 20 through conduit 42 and into lower plenum space 22 at the base of canister 16, through optional mesh and or diffuser plate 28, sorbent bed 18 and into upper section plenum space 24. The interior lower section plenum space 22 is defined by conduit 42, interior wall 30, base 32, and mesh and/or diffusion plate 28. Inlet 20, further comprises conduit 42, which defines the fluid flow of the effluent stream as traversing the upper plenum space 22, and sorbent bed section 18, of the canister, so as to flow process fluid into the lower section plenum space 22. The inlet and or conduit 42, may comprise filtering means and may terminate flush with mesh 28 at the base of sorbent bed 18 or project into lower section plenum space 22. Sorbent bed 18, bounded by lower mesh and or diffuser plate 28 and optional upper mesh 38 may comprise a dry resin sorbent material in particulate or monolith form. In order to provide the lower section plenum space 22 below the bed, a support (not shown) may be inserted into the canister in order to support the sorbent bed. The interior upper section plenum space 24 is defined by interior wall, 30, lid 36, optional mesh and/or sorbent bed 18 as base and outlet 26 where the effluent stream passes to house exhaust, further treatment or other disposition steps. Further means 46, may be provided for communication of canister process parameters to an external system such as a CPU and may include ancillaries such as thermowells into which may be inserted thermocouples to monitor the temperature of the sorbent bed during process abatement and optional air oxidation, and/or sensor tubes to monitor the concentration of toxic gas component in the gas stream at the 90% consumption point of the sorbent bed. The up-flow canister as described by such an embodiment provides for immediate retrofit of prior art down-flow canisters without tool downtime for system reconfiguration and/or canister change-out.

The inlet section of the up-flow canister necessarily enables the disposition of effluent gases into the lower-section, plenum space 22 and may advantageously couple to up-flow canister 16, in any one of several locations along its exterior perimeter.

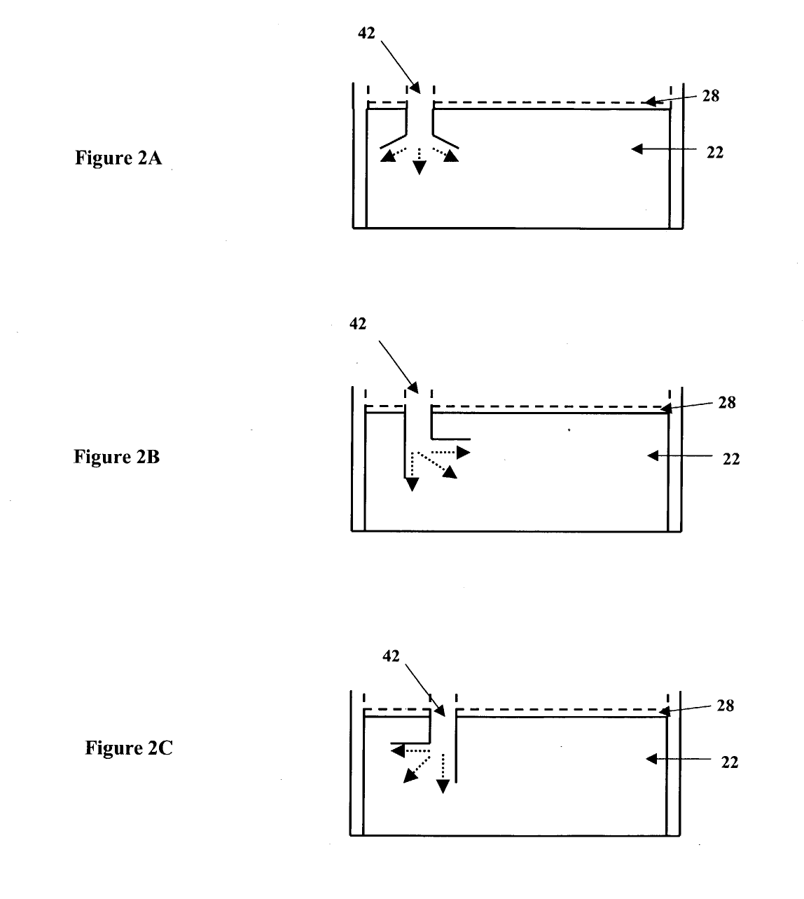

FIGS. 2, 3, 4 and 5 show various embodiments of the up-flow canister where the inlet entry has been modified to exemplify versatility in the container design, while maintaining the full advantage of the up-flow process effluent flow. In all such embodiments, the inlet may comprise means to increase the turbulence of effluent fluid flow upon entry into the lower plenum space, such means including but not limited to diffusion plate(s), baffle(s), shower-head type fittings and nozzles. Preferably the means by which the turbulence of fluid flow is increased generates a swirling motion in the fluid, causing the fluid to rise into the sorbent bed (not shown). In describing such embodiments, with respect to the FIGS. 2 through 5, like numerals will be used in accordance with FIG. 1B to identify similar features.

FIGS. 2A, 2B and 2C show one modification of the up-flow canister where conduit 42 traverses the length of both upper plenum space and sorbent bed sections (not shown) and terminates in the interior section of lower plenum space 22, of canister 16 (see FIG. 1B). FIG. 2A shows a full range of angles through which fluid may flow into the lower plenum space from conduit 42, while FIGS. 2B and 2C show more specific directional entry options.

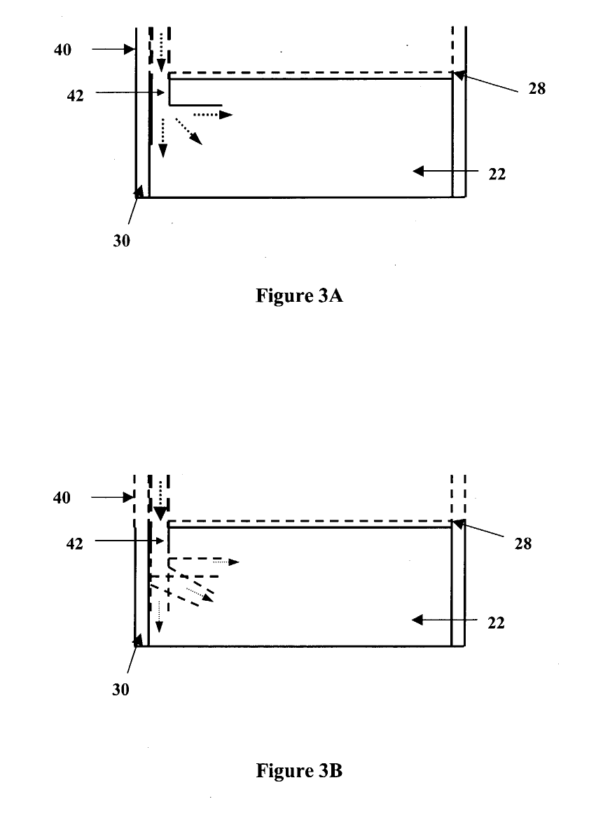

FIGS. 3A and 3B show a further modification of the up-flow canister, where conduit 42 traverses the length of both upper plenum space and sorbent bed sections (not shown) and terminates in lower plenum space 22, located along the interior wall 40, of canister 16 (see FIG. 1B). The inlet may terminate either flush with mesh 28 at the base of sorbent bed 18 (not shown) or project into the lower section plenum space 22. FIG. 3A shows the range of angles from 0° to 90° through which fluid may flow into the lower plenum space from conduit 42 and FIG. 3B shows more specific directional entry options.

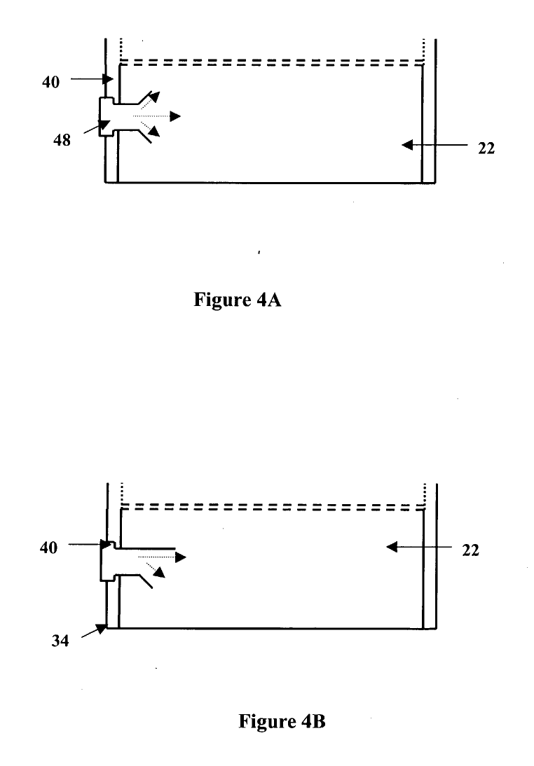

FIGS. 4A and 4B show an up-flow canister where inlet 48 has been modified to couple to sidewall 40 in lower section plenum space 22. In such modification, process effluent flows tangentially into lower plenum space 22, which creates a swirling motion, causing the effluent to rise into sorbent bed 18 (not shown). FIG. 4A shows a range of angles through which fluid may flow into the lower plenum space from inlet 48 and FIG. 4B shows a more specific directional entry option for such inlet.

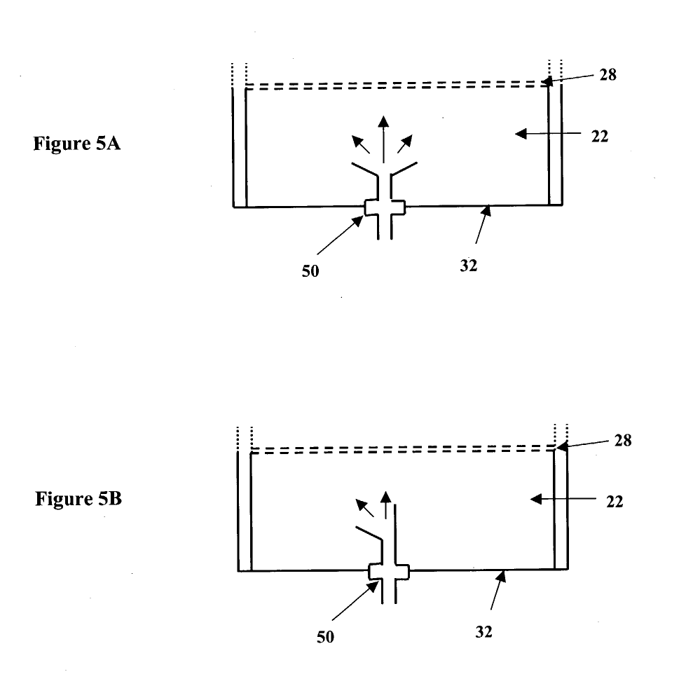

FIGS. 5A and 5B show an up-flow canister where inlet 50 has been modified to couple to canister base 32 in lower plenum space 22. Preferably process effluent enters the canister at its cross-sectional center at the canister base 32 (the cross-section being transverse to the flow direction of the gas stream being flowed through the bed). The inlet may terminate either flush with canister base 32 or project into the lower section plenum space 22 as shown in such Figures. FIG. 5A shows a range of angles through which fluid may flow into the lower plenum space from inlet 50 and FIG. 5B shows a more specific directional entry option for such inlet.

The novel up-flow canister design as described herein, reduces pressure drop across a sorbent bed thereby reducing the amount of resources expended for operation of a fluid motive force driver. As shown by the Ergun equation, outlined hereinabove, pressure drop is a function of process effluent flow velocity (Vₒ), the particular resin making up the fixed bed (ε=bed void fraction, Dₚ=characteristic resin particle diameter, ft and φₛ=sphericity of resin particle) the particular fluid motive force design, among other things. The up-flow canister reduces pressure drop by avoiding the convergence effects of the prior art canister.

The present invention, in a further embodiment, relates to an abatement system, comprising an up-flow canister joined in fluid flow communication with a semiconductor process apparatus, with the semiconductor process apparatus discharging an effluent gas stream to the up-flow canister for receiving and removing hazardous effluent species from the effluent gas stream, the up-flow canister comprising:

a lower section plenum space;

a center section space, for containment of a sorbent bed material;

an upper section plenum space;

an inlet in gas flow communication with the semiconductor process effluent stream, comprising means for introducing the process effluent stream to the lower section plenum space; and

an outlet comprising means for egress of the process effluent stream from the canister.

In a preferred embodiment, the abatement system comprising an up-flow canister, further comprises a fluid motive force-driving device for producing a negative pressure upstream of the abatement system. The motive force device, typically located downstream of the up-flow canister, draws fluid from its source (for example, a process pump outlet) through any process tubing, into the abatement system and through the sorbent bed and exhaust system. Preferably the fluid motive force-driving device maintains a pressure upstream of the canister and downstream of a process pump outlet, at a negative pressure. More preferably, the fluid motive force device, maintains such a pressure at between 760 and 700 Torr. Fluid motive force devices useful for producing negative pressures in such an abatement system include but are not limited to blowers, eductors and venturis.

In many semiconductor processes there are three modes of operation: (a) normal operation, when the semiconductor process reactor is processing a wafer, (b) chamber cleans, and (c) chamber pump-downs, when the semiconductor process chamber is initially being pumped down from atmospheric pressure to a low vacuum level (many semiconductor manufacturing processes are performed at low vacuum levels).

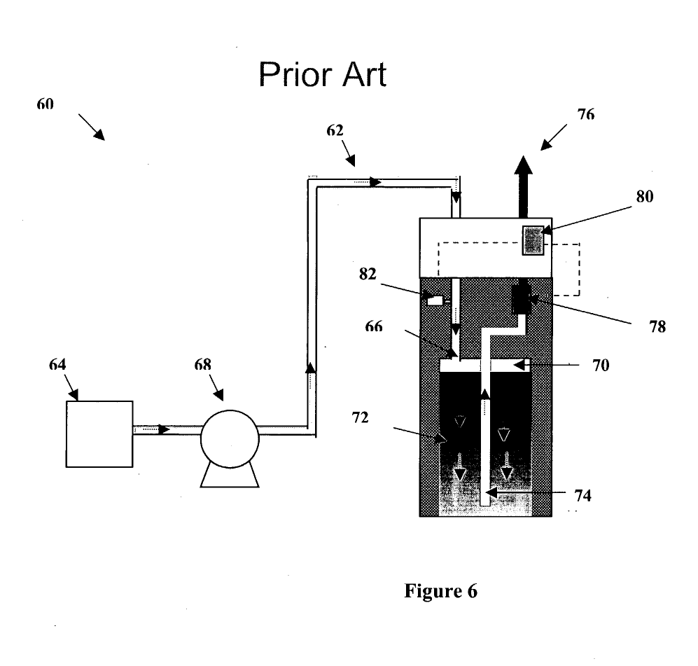

FIG. 6 shows a prior art fixed resin bed abatement system 60 used to target (chemisorb or physisorb) various effluent gas species. Process effluent 62 (shown by directional arrows) flows from semiconductor process reactor 64, to scrubber inlet 66, which is downstream from process pump 68, into plenum space 70, through sorbent bed 72 to convergence tube 74 and house exhaust 76. The pressure upstream of sorbent bed 72 is maintained at below atmospheric pressure by venturi 78 mounted just downstream of sorbent bed 72 regulated by pressure controller 80 and pressure transducer 82. Venturi 78 uses high pressure N₂ (not shown) to create a vacuum and the amount of N₂ used by venturi 78 is dependent upon to the pressure drop across the sorbent bed 72.

In accordance with the aforementioned Ergun equation, as effluent approaches convergence tube 74, locally high gas velocities occur, thereby resulting in high-pressure drops across sorbent bed 72. As shown by data provided in Tables 1 and 2 below, venturi 78, servicing such a prior art canister design will expend more N₂ than an up-flow canister design of the current invention. Advantageously, the up-flow canister design of the instant invention reduces pressure drop and eductor/venturi N₂ usage.

TABLE 1
Reduction in Pressure Drop for Up-flow vs. Down-flow
Configurations.

| | Minimum | | |
|---|---|---|---|
| Process Flow | Down-flow dP | Up-flow dP | % dP |
| (slpm) | (Torr) | (Torr) | Reduction |
| 80.5 | 0.78 | 0.35 | 54.8% |
| 120.8 | 1.38 | 0.54 | 60.8% |
| 181.4 | 2.60 | 0.82 | 68.3% |

TABLE 2
Eductor/Venturi N2 Savings with Up-flow Can

| | Eductor Use - | Eductor Use - | |
|---|---|---|---|
| Process Flow | Down-flow | Up-flow | % N2 savings |
| (slpm) | Canister (slpm) | Canister (slpm) | with Up-flow |
| 80.5 | 36.7 | 27.1 | 26.2% |
| 120.8 | 48.3 | 30.7 | 36.4% |
| 181.4 | 70.4 | 36.3 | 48.4% |

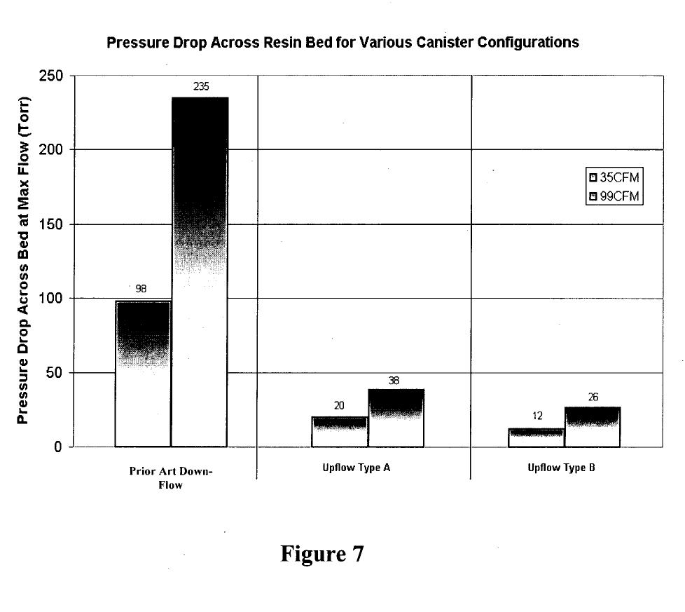

FIG. 7 shows a direct comparison in the form of a bar graph of pressure drop reduction resulting from an up-flow canister design with respect to a prior art down-flow canister design, at flow rates of 35 and 99 CFM. Up-flow canister design Type “A” having a two inch upper plenum space and two inch lower plenum space, and canister design Type “B” having a six inch lower plenum space and a four inch upper plenum space, both show a significant improvement from 98 to as low as 12 Torr at 35 CFM and from 235 to as low as 26 Torr at 99 CFM.

Thus, in a further embodiment, the instant invention reduces pressure drop across a fixed sorbent bed that occurs during semiconductor process chamber pump-downs by as much as an order of magnitude.

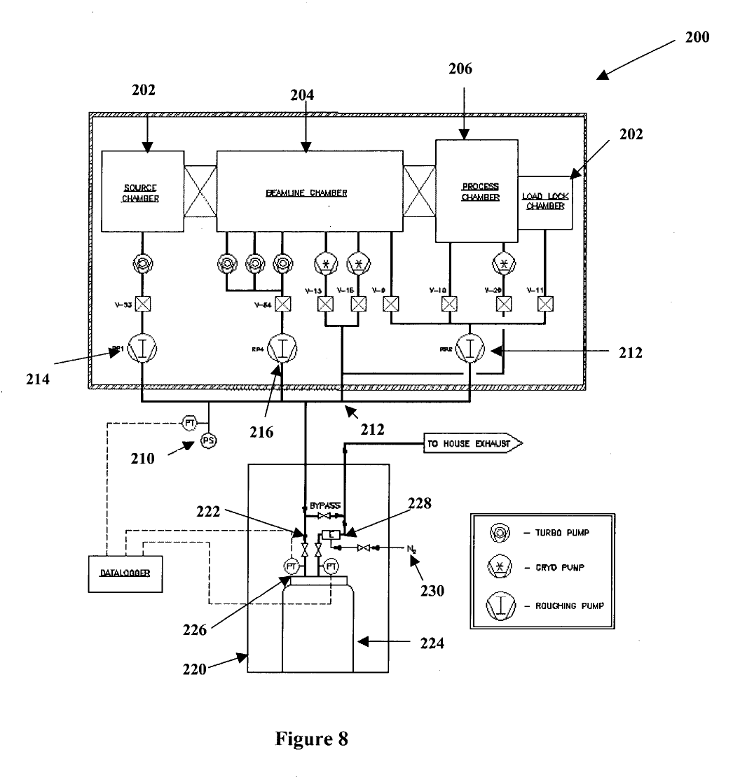

FIG. 8 shows a schematic of a typical ion implant system 200, comprising source chamber 202, beam line chamber 204, process chamber 206 and load lock chamber 208. A pressure switch 210, located in the common manifold 212, of the implant outlet, downstream from the various process pumps 214, 216, and 218 may be set to pressure, for example, in a range of from about −4.0 Torr to 150 Torr. When pressure switch 210 senses a pressure in manifold 212 exceeding the pressure set point, pressure switch 210 trips and shuts down pumps 214, 216, and 218.

Ion-implant system 200, routinely operates under parameters, which are sub-atmospheric. Tool downtime occurs for routine maintenance cleans as well as for repairs. Process chamber pump-downs, to bring the system back on line result in very large (yet transient) flows being sent to the fixed bed abatement system 220, creating a momentary pressure drop in which the pressure upstream 222 of the fixed bed 224 is considerably higher than atmospheric pressure. The upstream flow results in a backpressure, exceeding the pressure set point, tripping pressure switch 210.

Further, when a pressure signal measured at inlet pressure transducer 226, coupled with pressure controller (not shown) and fluid motive force driver-eductor 228 is outside a predetermined pressure range (typically sub-atmospheric), the pressure controller increases or decreases the fluid flow of nitrogen 230 or other gas controlling eductor 228 to bring the pressure at the inlet back into specification.

The backpressure from such system pump-downs negatively affects the prior art abatement system performance, where the potential for super-atmospheric pressures can result in a release of fluid to a facility and/or environment. The instant invention, advantageously improves the incidence of system shutdowns, by reducing the backpressure upstream of the abatement system, without increasing the charge to the fluid flow motive force device.

As an alternative or additional means by which to maintain pressures upstream of the up-flow canister below atmospheric as well as to reduce back-pressures resulting from chamber pump-downs is through use of a flow-dampening device. Thus, in a further embodiment, the up-flow canister abatement system of the instant invention is used in combination with a flow-dampening device, such as a soft start flow-limiting device, available commercially from MKS Instruments under the brand name Auto-Soft®. The flow-limiting device is preferably placed at a roughing pump inlet and serves to reduce the maximum pressure upstream of the sorbent bed during chamber pump-downs and to maintain pressures below atmospheric pressure during normal operation effluent processing. Advantageously, the up-flow canister abatement system in combination with a flow-dampening device reduces the need for a fluid motive force driver device downstream of the sorbent bed, assuming a normal house exhaust draw of from about 1.0 to 6.0 Torr.

Compounding the pressure-drop across a prior art abatement system is the poor fluid-flow distribution through the dry resin bed, caused by the locally high gas velocities occurring in the area of the convergence tube (See FIG. 1A, Prior Art).

The temperature within a local area of a fixed sorbent bed is a function of the rate of reaction between the reactive gas component(s) and the sorbent material, per unit volume of sorbent. Thus, in areas of the sorbent bed where convergence occurs, temperatures increase (hot spots) due to an increase in the concentration of the reactants. As temperature increases, the probability of secondary reactions within the sorbent bed also increases. One typical secondary reaction, which typically begins around 120° C., occurs between hydrogen and a copper oxide component of certain resin materials. Advantageously, the up-flow canister of the instant invention improves fluid-flow dynamics through a sorbent bed, thereby reducing incidence of localized hot spots.

Sorbent-based abatement systems rely on momentum transfer of a fluid stream to the sorbent bed such that the fluid stream flows into the sorbent bed, contacts the sorbent bed and reacts therewith in an evenly distributed manner thereby creating a uniform fluid front or mass transfer zone (MTZ), which theoretically transfers evenly through the sorbent system. To promote the even distribution of fluids into the sorbent bed, the up-flow canister, in a further embodiment of the instant invention, increases fluid flow uniformity in a sorbent bed by providing for a pressure drop within the first 1/10 of the bed that is about 10× the value of the kinetic energy (½ρv²) of the inlet gas. For example, a sorbent system having an inlet flow rate of 140 slpm in a 3.81 cm. outer diameter (O.D.) tube, has a required bed pressure drop of 3.31 Torr/meter resin height.

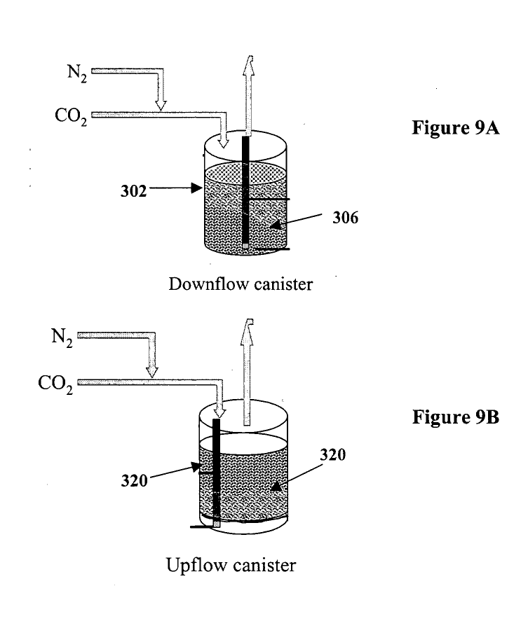

FIGS. 9A and 9B show a comparison of fluid flow distribution, using prototypes, between a prior art down-flow canister and an up-flow canister. Down-flow canister 302 and up-flow canister 352 were filled with an indicating resin, which when exposed to CO₂ changed color from white to purple. A CO₂, N₂ mixture was flowed at 5 slpm into canisters 302 and 352 both having upstream pressures of around 720 Torr. Solvent front 306 in down-flow canister 302 displays a very uneven usage of resin in contrast to a more uniform reaction front 306 in up-flow canister 352 before CO₂ breakthrough.

The up-flow configuration inherently increases the resin utilization capabilities as a result of uniform fluid flow. Advantageously, chemisorption and/or physisorption capacity of a sorbent bed may improve by from about 10 to 30 percent as a direct result of improving flow uniformity. Such an improvement can be attributed to an absence of the convergence effect present in the prior-art, down-flow canister, where process fluids converging at the bottom of the canister, prevented the utilization of large quantities of sorbent.

An additional means by which to decrease the pressure drop across a sorbent bed system and increase fluid flow uniformity is through canister geometry re-design. In one embodiment, the instant invention relates to a canister having a cubic geometry. Such a geometry change affords a cross-sectional area increase of as much as 28 percent for a given diameter and length. As the cross-sectional area of the canister increases, the fluid velocity decreases. As the fluid velocity decreases, so too does the pressure drop across the sorbent bed, in accordance with the Ergun equation. Preferably, the canister having a cubic geometry is of an up-flow design.

The cubic geometry having a cross sectional increase of as much as 28 percent advantageously, translates to an increase in sorbent material available to serve as a heat sink. For example, a canister having a cubic geometry can absorb up to 27.3 percent more heat than a cylindrical canister having the same diameter and length. Instead of a particular sorbent bed system reaching a temperature of 120° C., it will only reach 92.7° C. (assuming an initial temperature of 20° C.).

In semiconductor processes, specifically MOCVD, where large amounts of hydride gases such as arsine, phosphine, germane, diborane, and silane are present in process effluent streams, local hot spots due to poor flow distribution often occur in the sorbent bed. When temperatures increase in the sorbent bed to certain critical temperatures, secondary reactions are possible. The secondary reactions can cause uncontrolled temperature excursions, making the bed unusable and creating a hazardous situation. For example, in MOCVD processes using sorbent beds comprising for example CuO, there is a potential for a secondary reaction to occur when temperatures in the sorbent bed increase to around 120° C. The secondary ballast gas (H₂) begins reducing the Cu²⁺ and the sorbent bed rises to temperatures in excess of 600° C. The up-flow canister of the present invention, serves to reduce the occurrences of secondary reactions, by either increasing fluid flow uniformity or increasing the sorbent bed available to serve as a heat sink through geometry redesign or both.

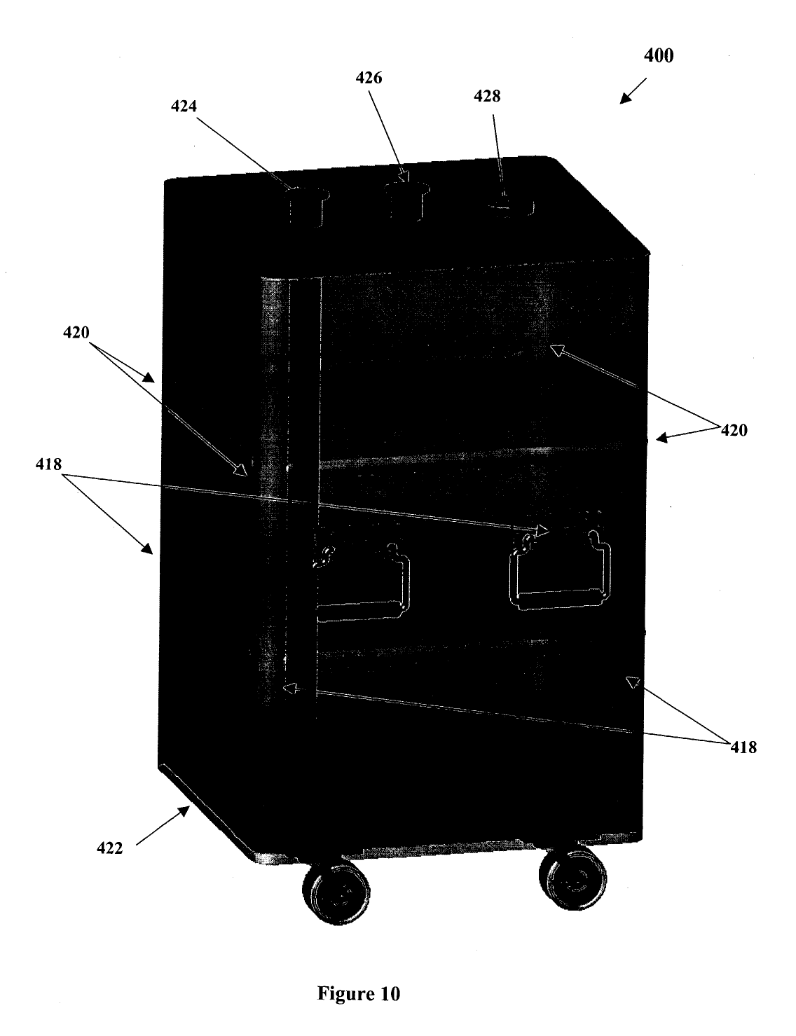

FIG. 10 shows a cubic shaped canister 400, according to one embodiment of the present invention. The canister comprises a substantially rigid and shreddable receptacle having opposedly facing front and back walls 418 and opposedly facing sidewalls 420, and a floor member 422. The canister comprises at least a first port 424, accommodating coupling of canister 400 with a semiconductor process effluent stream and a second port 426, for exhaustion of process effluent stream from the container. The canister may be manufactured from materials such as carbon steel and/or stainless steel. The cubic shaped canister, may optionally comprise a thermowell 428, into which may be inserted a thermocouple to monitor the temperature of the interior of canister 400, during process abatement and air oxidation, and a sensor tube to monitor the concentration of toxic components in a process effluent stream at, for example, the 90% consumption point of a dry sorbent bed.

In a further embodiment, the present invention provides a particle removal system, comprising, a first section plenum space, where effluent process fluids comprising toxic gas components and hazardous particulate matter are introduced; a sorbent bed section for treating the process fluids comprising pollutants, to achieve a target abatement performance; and a second plenum space where treated effluent passes prior to being exhausted from the system, wherein said first plenum space advantageously serves as a particle trap. Thus, the present invention reduces particulate matter in an effluent process stream.

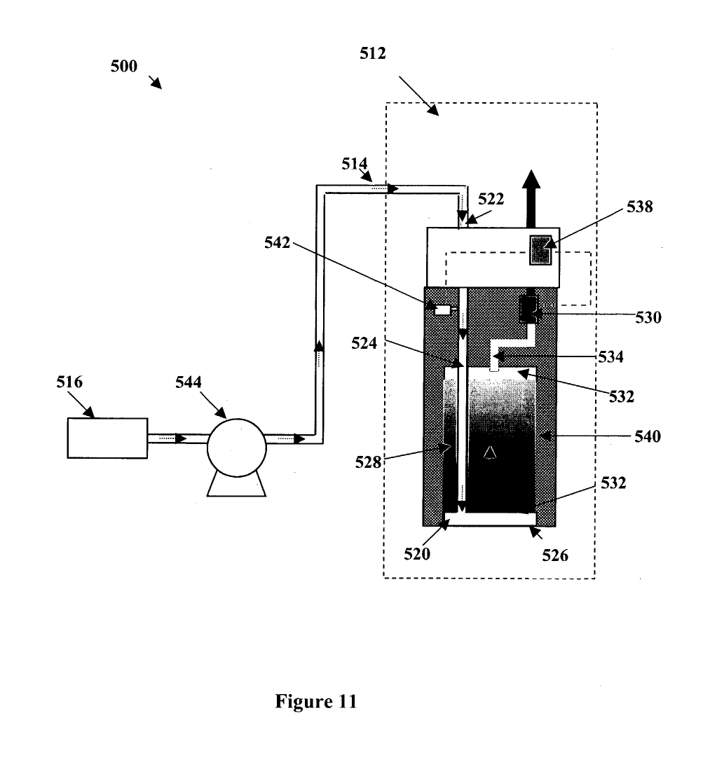

Referring to FIG. 11, there is shown a process tool 500 using a point of use abatement apparatus 512 comprising up-flow canister 540, according to one embodiment of the present invention. The effluent stream (shown by directional arrows) deriving from semiconductor process tool 516 is introduced into abatement apparatus 512 through inlet 522 comprising conduit 524. The effluent stream comprising a pre-scrub concentration of toxic gas component, and hazardous particulate matter, flows into lower section 520 of abatement apparatus 512, from process tool 516, pump 544, process line 514, scrubber inlet 522 and conduit 524, where the effluent stream mixes and expands. Particles of a predefined mass and size will preferentially deposit on canister base 526 of lower section plenum space 520, while process fluid is mass transported into sorbent bed section 528, in an up-flow direction, by a pressure differential induced by fluid motive force driver device 530 in fluid flow communication with pressure controlling device 538 and pressure transducer 542. The toxic gas component contacts mesh/diffusion plate (not shown) and/or sorbent material 528, and the sorbent material, having an affinity for the toxic gas component retains thereon and/or reacts therewith, the toxic gas component, thereby reducing the concentration of the toxic gas component.

The effluent stream having a reduced concentration of toxic component and hazardous particulate matter, exits the sorbent bed section 28 and flows into the upper section plenum space 32 where it again, expands and mixes. The effluent stream exits canister 40 through outlet port 34 where the effluent stream passes to further treatment or other disposition steps.

An end point monitor (not shown) may be coupled to an output module for outputting an indication of breakthrough of the contaminant(s) in the effluent gas stream when the capacity of the scrubber bed for active processing of the effluent gas stream is exhausted or reaches a predetermined approach to exhaustion (e.g., reaches a point of exhaustion of 95% of the total capacity of the dry scrubber material).

In a further embodiment, the up-flow canister of the present invention is related to a particle trap, which allows for improved handling of particulate matter often present in process effluent streams of semiconductor processes.

One way in which particulate matter separates from a process effluent stream is by settling out at the bottom of the canister in the lower plenum space (i.e., a gravitational separator), which is in contrast to prior art down-flow systems where particles settled out and formed a cake on top of the sorbent bed. The enhanced particle handling capabilities of the up-flow configuration improve the canister's resistance to plugging and/or pressure drop increase over time. As a fluid motive force transports process effluent into the sorbent bed through the inlet and into the lower plenum space, the effluent fluid resides in the plenum space for a period of time prior to contacting the scrubbing medium contained in the sorbent bed. The higher the residence time in the plenum space, the higher the probability that a particle having a diameter of a particular size will remain in the plenum space and the more efficient the reaction kinetics (for example chemisorption) between an active component of the effluent stream and the sorbent bed.

To determine whether a given particle will be separated from a gas phase, the terminal velocity of the particle and how long the particle remains in the separator, are determined (Scweitzer, P. A., Handbook of Separations Techniques for Chemical Engineers, 3rd ed. 1997, McGraw-Hill). The terminal velocity is obtained from a force balance on the particle and is given by the expression below:

Uₜ=[4*g*Dₚ*(ρₚ−ρ_{f})/(3*C_{d}*ρ_{f})]^{1/2}

Where

Uₜ=terminal velocity

g=gravitational constant

Dₚ=particle size

ρₚ=particle density

ρ_{f}=fluid density

C_{d}=drag coefficient

The drag coefficient can be determined by a secondary relation such as that proposed by Haider and Levenspiel (Powder Technology, 58 63, 1989). However, for Reynold's numbers (RE)<2, the following relation can be used:

C_{d}=24/RE

Where:

RE=Reynold's Number

RE=Dₚ*Uₜ*ρ_{f}/μ_{f}

μ_{f}=fluid viscosity

The efficiency of the separator is then given by:

G=t_{particle}/t_{settling}=Uₜ*W*L/Q

Where G=grade efficiency

t_{particle}=residence time of particle in settling tank

t_{settling}=time for particle to settle in tank

W=width of tank

L=length of tank

Q=fluid flow rate

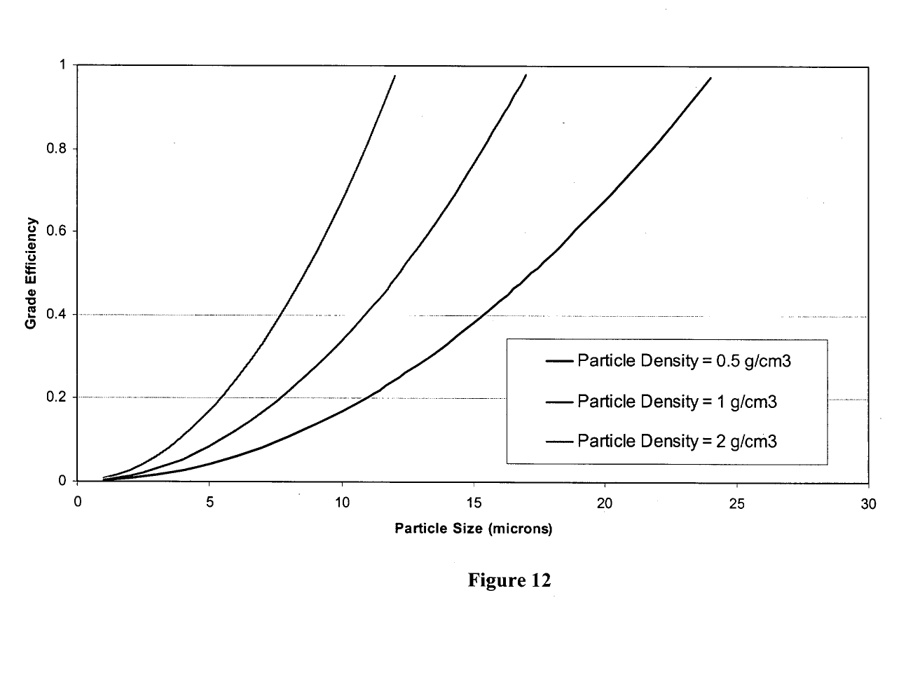

FIG. 12 shows a plot of particle trapping efficiency of an up-flow canister as a function of particle size, according to one embodiment of the present invention. The particle trapping efficiency is a function of incoming flow rate (100 slpm) and canister dimensions, as shown above. In the case of the up-flow canister used to obtain the results shown in FIG. 12, the canister included a one-inch lower plenum space having an equivalent length and width of a 16.8 inch square (a square of this dimension has the same area as a circle of diameter 19 inch).

The instant invention, may further comprise effluent flow circuitry to which an up-flow canister is coupled for dispensing of an effluent stream from a semiconductor process tool to the abatement system of the instant invention and may be advantageously configured, in one embodiment, as a dual or multi-bed system, comprising at least two containers holding respective beds of dry scrubber material, and arranged for cyclic alternating and repeating operation.

Alternatively, the up-flow canister may serve as a primary abatement system for a particular semiconductor process, a component of a larger abatement system comprising other ancillary abatement means, an intermediate system between canister change-outs, as a back-up for main abatement system failure, as a point of use scrubber in a gas cabinet exhaust line, or as an emergency portable abatement system.

In one embodiment, the instant invention relates to an emergency response scrubber system comprising an up-flow canister as described herein and having a canister volume of from about 0.1 to 25 liters. Such a system may be useful where a temporary and quick response is needed to manage and/or contain an effluent process stream release, (for example, a leaking valve) which if not managed or contained poses a hazardous situation to its immediate and/or surrounding environment. Potential uses where such an emergency response scrubber system would have utility include but are not limited to duct work to handle a release from a gas cabinet, hood, or cylinder storage room.

The emergency response scrubber system comprising an up-flow canister may further comprise a zero-footprint solution to space limitations where process tool maintenance or downtime requires a portable system for prevention of a potential release of a temporary toxic gas component from entering its immediate environment.

The present invention also, optionally, may comprise a means of sensing process fluid effluent for the purpose of monitoring and/or controlling the invention at desired and/or optimal operating conditions. Optional detectors can be located in the invention to monitor target components. Such information may then be fed back to control the abatement parameters, such as temperature and feed rate of individual reagents etc. End-point monitors useful in the present invention are readily determined by those skilled in the immediate art, including but not limited to: thermopile, electromagnetic, electrochemical, photochemical, photochromic, piezoelectric, and MEMs.

The sorbent material used in the up-flow canister of the present invention may react with contaminants in an effluent stream (adsorbate) by physical or chemical adsorption kinetics. Physical adsorption is due to intermolecular forces between an adsorbent and adsorbate (e.g. van der Waals interactions) and thus is reversible. Chemical adsorption involves a chemical reaction between the adsorbent and the adsorbate. Preferably the up-flow canister of the present invention utilizes a dry scrubbing medium having a chemisorption relationship with process contaminants.

The abatement system of the instant invention, preferably comprises a dry resin sorbent bed. The dry resin may comprise any combination of resins useful for scrubbing process gases specific to the particular process tool requiring effluent abatement and may be readily determined by those of skill in the art. Sorbent bed materials include but are not limited to: carbon, CuSO₄, Cu(OH₂), CuO, CuCO₃, CuCO₃.Cu(OH)₂, Cu₂O, MnOₓ, wherein x is from 1 to 2 inclusive, AgO, Ag₂O, CoO, Co₃O₄, Cr₂O₃, CrO₃, MoO₂, MoO₃, TiO₂, NiO, LiOH, Ca(OH)₂, CaO, NaOH, KOH, Fe₂O₃, ZnO, Al₂O₃, K₂CO₃, KHCO₃, Na₂CO₃, NaHCO₃, NH₃OH, Sr(OH)₂, HCOONa, BaOH, KMnO₄, SiO₂, ZnO, MgO, Mg(OH)₂, Na₂O₃S₂, SiO₂, triethylenediamine (TEDA) and mixtures thereof.

Additionally, the sorbent material may further comprise a stabilizer or the active component may be impregnated into or coated onto an adsorbent substrate. Stabilizing materials help in the manufacturing of the sorbent media (e.g. in extrusion), and in some situations serves to prevent the sorbent media from decomposing. Useful stabilizers include but are not limited to the elements Be, Mg, transition metals selected from V, Mo, Co, Ni, Cu, Zn, B, Al, Si, Pb, Sb, Bi and oxides, hydroxides hydrogen carbonates, hydrogen sulfates, hydrogen phosphates, sulfides, peroxides, halides, carboxylates, and oxy acids thereof.

Process fluids usefully abated by the instant invention are not limited within the broad scope of the present invention. Exemplary gases include but are not limited to: AsH₃, PH₃, SbH₃, BiH₃, GeH₄, SiH₄, NH₃, HF, HCl, HBr, Cl₂, F₂, Br₂, BCl₃, BF₃, AsCl₃, PCl₃, PF₃, GeF₄, AsF₅, WF₆, SiF₄, SiBr₄, COF₂, OF₂, SO₂F₂, SOF₂, WOF₄, CIF₃ (hfac)In(CH₃)₂H₂As(t-butyl), H₂P(t-butyl), Br₂Sb(CH₃), SiHCl₃, SiH₂Cl₂, 3MS, 4MS, and TMCTS.

The up-flow canister as described herein may further comprise specific features and modifications such as additional plenum spaces distributed between successive sorbent beds, for further regulation of process effluents, heat exchange coils disposed interior or exterior to the sorbent bed, sorbent bed regeneration means, and effluent process lines coupled to gas distributor elements and/or baffles within the canister, which serve to manipulate distribution of introduced gas throughout the container.

Accordingly, while the invention has been described herein with reference to specific features and illustrative embodiments, it will be recognized that the utility of the invention is not thus limited, but rather extends to and encompasses other features, modifications and alternative embodiments as will readily suggest themselves to those of ordinary skill in the art based on the disclosure and illustrative teachings herein. The claims that follow are therefore to be construed and interpreted as including all such features, modifications and alternative embodiments within their spirit and scope.

What is claimed is:

1. An up-flow canister comprising:
a lower section plenum space;
a center section space, for containment of a sorbent bed material;
an upper section plenum space;
an inlet comprising means for introducing a process effluent stream to the lower section plenum space; and
an outlet comprising means for egress of said process effluent stream from said canister.

2. The up-flow canister according to claim 1, having a cylindrical or cubic geometry.

3. The up-flow canister according to claim 1, having a volume that is between 0.1 to 1000 liters.

4. The up-flow canister according to claim 1, wherein said sorbent bed is dry resin.

5. The up-flow canister according to claim 1, wherein said sorbent material is selected from the group consisting of carbon, CuSO₄, Cu(OH₂), CuO, CuCO₃, CuCO₃.Cu(OH)₂, Cu₂O, MnOₓ, wherein x is from 1 to 2 inclusive, AgO, Ag₂O, CoO, CO₃O₄, Cr₂O₃, CrO₃, MoO₂, MoO₃, TiO₂, NiO, LiOH, Ca(OH)₂, CaO, NaOH, KOH, Fe₂O₃, ZnO, Al₂O₃, K₂CO₃, KHCO₃, Na₂CO₃, NaHCO₃, NH₃OH, Sr(OH)₂, HCOONa, BaOH, KMnO₄, SiO₂, ZnO, MgO, Mg(OH)₂, Na₂O₃S₂, SiO₂, triethylenediamine (TEDA) and mixtures thereof.

6. The up-flow canister according to claim 5, wherein said sorbent material further comprises a stabilizer selected from the group consisting of Be, Mg, V, Mo, Co, Ni, Cu, Zn, B, Al, Si, Pb, Sb, Bi and oxides, hydroxides hydrogen carbonates, hydrogen sulfates, hydrogen phosphates, sulfides, peroxides, halides, carboxylates, and oxy acids thereof.

7. The canister according to claim 1, wherein said process fluid effluent stream is mass transported into the sorbent bed section, in an upward direction, by a pressure differential.

8. The up-flow canister according to claim 1, wherein said inlet enables the disposition of effluent gases into the lower-section, plenum space.

9. The up-flow canister according to claim 1, wherein said inlet comprises means to increase the turbulence of effluent fluid flow upon entry into the lower plenum space.

10. The up-flow canister according to claim 9, wherein said means to increase turbulence is selected from the group consisting of diffusion plate(s), baffle(s), shower-head type fittings and nozzles.

11. The up-flow canister according to claim 1, wherein said inlet traverses the length of both upper plenum space and sorbent bed and terminates in the lower plenum space.

12. The up-flow canister according to claim 1, wherein said inlet is located along an inner wall of said canister and traverses the upper plenum space and the sorbent bed and terminates in said lower plenum space.

13. The up-flow canister according to claim 1, wherein said inlet couples to a sidewall of said canister.

14. The up-flow canister according to claim 1, having a base, wherein said base couples with said inlet.

15. The up-flow canister according to claim 14, wherein said inlet couples to canister base in lower plenum space 22.

16. The up-flow canister according to claim 14, wherein said process effluent stream enters the canister at a cross-sectional center of the canister base.

17. The up-flow canister according to claim 1, joined in fluid flow communication with a semiconductor process apparatus, with the semiconductor process apparatus discharging an effluent gas stream to the up-flow canister for receiving and removing hazardous effluent species from the effluent gas stream.

18. The up-flow canister according to claim 1, further comprising a fluid motive force-driving device for producing a negative pressure upstream of the up-flow canister.

19. The up-flow canister according to claim 18, wherein said fluid motive force-driving device maintains a pressure upstream of the canister at a negative pressure.

20. The up-flow canister according to claim 18, wherein said fluid motive force is selected from the group consisting of blowers, eductors and venturis.

21. The up-flow canister according to claim 1, wherein said process effluent stream comprises at least one component selected from the group consisting of AsH₃, PH₃, SbH₃, BiH₃, GeH₄, SiH₄, NH₃, HF, HCl, HBr, Cl₂, F₂, Br₂, BCl₃, BF₃, AsCl₃, PCl₃, PF₃, GeF₄, AsF₅, WF₆, SiF₄, SiBr₄, COF₂, OF₂, SO₂F₂, SOF₂, WOF₄, CIF₃ (hfac)In(CH₃)₂H₂As(t-butyl), H₂P(t-butyl), Br₂Sb(CH₃), SiHCl₃, SiH₂Cl₂, 3MS, 4MS, and TMCTS.

22. The up-flow canister according to claim 1, wherein said lower plenum serves as a particle trap.

23. The up-flow canister according to claim 1, further comprising an end point monitor.

24. The up-flow canister according to claim 23, wherein said end-point monitor is selected from the group consisting of thermopile, electromagnetic, electrochemical, photochemical, photochromic, piezoelectric, and MEMs.

25. An abatement system, comprising an up-flow canister joined in fluid flow communication with a semiconductor process apparatus, with the semiconductor process apparatus discharging an effluent gas stream to the up-flow canister for removing hazardous effluent species from the effluent gas stream.

26. An abatement system, comprising an up-flow canister joined in fluid flow communication with a semiconductor process apparatus, with the semiconductor process apparatus discharging an effluent gas stream to the up-flow canister for receiving and removing hazardous effluent species from the effluent gas stream, the up-flow canister comprising:
a lower section plenum space;
a center section space, for containment of a sorbent bed material;
an upper section plenum space;
an inlet comprising means for introducing the process effluent stream to the lower section plenum space, said inlet in gas flow communication with the semiconductor process effluent stream; and
an outlet comprising means for egress of the process effluent stream from the canister.

27. A method for reducing the concentration of a toxic gas component in a semiconductor process effluent stream, comprising:
introducing an effluent gas stream comprising a toxic gas component into an up-flow canister, said up-flow canister comprising:
a lower section plenum space;
an upper section plenum space;
a center section comprising a sorbent bed material;
an inlet comprising means for introducing a process effluent stream to the lower section plenum space; and
an outlet comprising means for egress of said process effluent stream from said canister; and
contacting the effluent stream with a sorbent material that is reactive with the toxic gas component, to substantially remove the toxic component therefrom,
wherein said effluent gas stream flows into the sorbent bed, in an upward direction, by a pressure differential.

28. A canister for coupling with an abatement system, wherein said canister comprises a cubic geometry.

29. The cubic canister according to claim 28, comprising at least an upper and lower plenum space and a sorbent bed therebetween.

30. An emergency response scrubber system comprising an up-flow canister.
